(19) United States
(12) Patent Application Publication
(10) Pub. No.: US 2007/0243747 A1
(43) Pub. Date: Oct. 18, 2007

(54) Multi-purpose utility clasp apparatus

(76) Inventors: Terry Kinskey, Alpharetta, GA (US); Matthew Williams, Lighthouse Point, FL (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/714,675

(22) Filed: Mar. 5, 2007

Related U.S. Application Data
(60) Provisional application No. 60/778,676, filed on Mar. 3, 2006.

(51) Int. Cl. H01R 13/627

(52) U.S. Cl. 439/352

(57) ABSTRACT

A utility clasp apparatus, including a first plate, a second plate parallel to the first plate and a set of opposable claws disposed between the first and second plates. The utility clasp apparatus typically provides a closed loop that is disposed in a channel for receiving items to be retained within a channel defined about the closed loop.

### RELATED APPLICATIONS

The present Nonprovisional Application is related to, and hereby claims priority to, and the benefit of, U.S. Provisional Application No. 60/778,676, entitled “Multi-Purpose Utility Clasp Apparatus,” filed on Mar. 3, 2006.

### BACKGROUND

I. Field of the Invention

The present invention relates generally to the field of utility clasps and more particularly to a multi-purpose utility clasp apparatus.

II. Description of the Related Art

There are a variety of needs to connect or secure items to other items. There are also needs to connect items to surfaces or transporters. However, there typically lacks sufficient apparatuses that can be used to securely fasten items. Furthermore, many suitable apparatuses are difficult to handle because sufficient force is required to open and close apparatuses to fasten items. There persists a need for a utility clasp having the ability to securely grasp a point of contact to an item or an item to an item. There further exists a need for a utility clasp that requires a minimal force to place into an open and closed position, but requires a substantially larger force to release an item from its grasp.

### SUMMARY

In general, the invention features a multi-purpose utility clasp apparatus, known also as a CRAB CLAW™.

In general, in one aspect, the invention features a utility clasp apparatus, including a first plate, a second plate parallel to the first plate and a set of opposable claws disposed between the first and second plates.

In one implementation, the set of opposable claws includes a first claw half and a second claw half having a common pivot point with the first claw half, wherein the first claw half and the second claw half include a partial overlap pattern.

In another implementation, the first claw half and the second claw half each include a base, an outer side portion connected to the base and a claw portion connected to the outer side portion, wherein the base, outer side portion and claw portion are integrally connected and generally form a C-profile.

In another implementation, the base portions of the opposable claws are in mechanical contact.

In another implementation, the claw portions are in mechanical contact when the opposable claws are in a closed position.

In another implementation, the base portions, the outer side portions and the claw portions form a closed loop when the opposable claws are in a closed position.

In another implementation, the first claw half and the second claw half each further comprise a grip portion integrally connected to the base.

In another implementation, the grip portions are for pivoting about a pivot point defined between the bases.

In another implementation, the grip portions are for being pressed toward one another to place the opposable claws in an open position.

In still another implementation, the apparatus further includes a pair of parallel stop-plates disposed on a lower end of the first and second plates and generally perpendicular to the first and second plates.

In another implementation, the stop-plates limit the motion of the grips when the opposable claws are placed in an open position.

In another implementation, the apparatus further includes a peak disposed on each of the first claw half and the second claw half.

In another implementation, the peaks are disposed on a border between the outer side portion and the claw portion.

In another implementation, the first plate and the second plate each comprise a set of prong pairs defining a channel therebetween.

In another implementation, the apparatus further includes a peg disposed between and generally perpendicular to the first and second plates a terminal end of each of the prong pairs.

In another implementation, the pegs are for limiting the motion of the opposable claws

In another implementation, the peaks are in mechanical contact with a respective peg when the opposable claws are in a closed position thereby forming a closed loop.

In another implementation, the apparatus further includes a channel formed in an end of the first plate and the second plate.

In another implementation, the opposable claws form a closed loop within the channel when the opposable claws are in a closed position.

In another implementation, the claw portions form an overlapping gate to the channel.

In yet another implementation, the overlapping gate prevents an item from being moveable from the channel.

In another implementation, the first plate is positioned in a first plane of orientation and the second plate is positioned in a second plane of orientation.

In another implementation, the first claw half is positioned in a third plane of orientation and the second claw half is positioned in a fourth plane of orientation.

In another implementation, the apparatus further includes a band disposed between and protruding from the first plate and the second plate.

In another implementation, the band is connected between the plates via a through pin disposed between the plates.

In another implementation, both ends of the through pin terminate in a support plate disposed perpendicular to and in mechanical contact with the first and second plates.

In another implementation, the apparatus further includes a utility loop connected to one end of the band.

One advantage of the invention is that it provides opposable claws that require little force to place in an open position and closed position.

Another advantage of the invention is that the opposable claws form a closed loop that typically locks an item into a channel.

Other objects, advantages and capabilities of the invention are apparent from the following description taken in conjunction with the accompanying drawings showing the preferred embodiment of the invention.

### BRIEF DESCRIPTION OF THE DRAWINGS

FIG. 1 illustrates a front view of an embodiment of a multi-purpose utility clasp apparatus in a closed position;

FIG. 2 illustrates a front view of an embodiment of a multi-purpose utility clasp apparatus in an open position;

FIG. 3 illustrates a side view of an embodiment of a multi-purpose utility clasp apparatus; and

FIG. 4 illustrates a front view of an embodiment of opposable claws in an open position.

### DETAILED DESCRIPTION

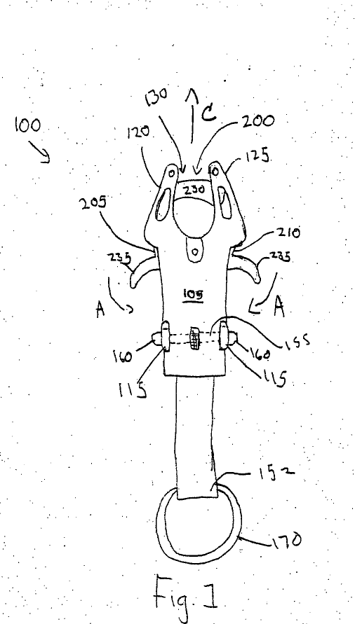

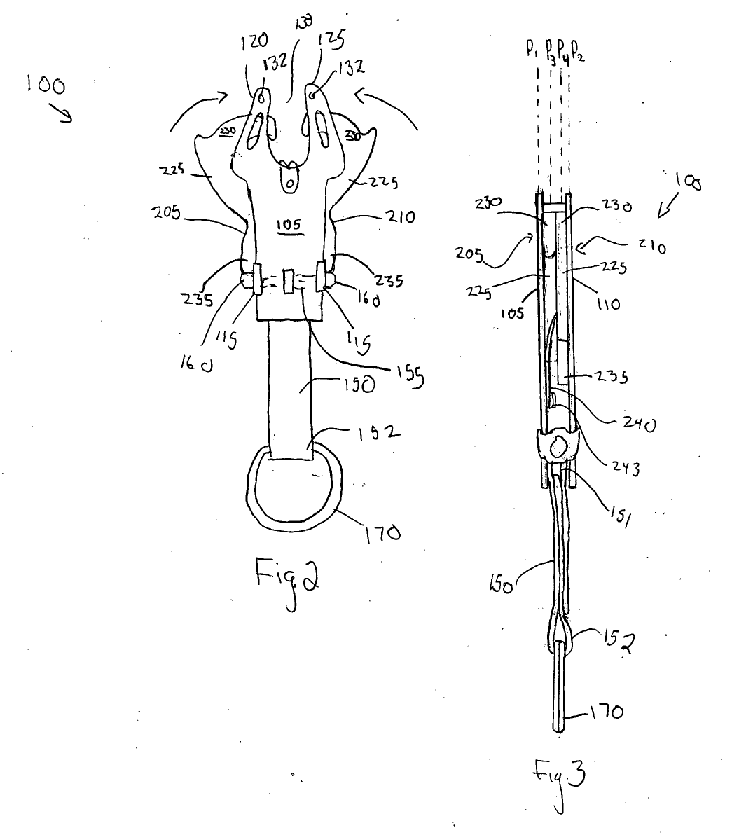

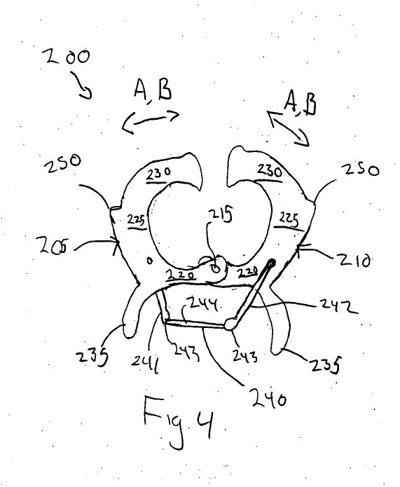

Referring to the drawings wherein like reference numerals designate corresponding parts throughout the several figures, reference is made first to FIG. 1, which illustrates a front view of an embodiment of a multi-purpose utility clasp apparatus 100 in a closed position. FIG. 2 illustrates a front view of an embodiment of a multi-purpose utility clasp apparatus 100 in an open position and FIG. 3 illustrates a side view of an embodiment of a multi-purpose utility clasp apparatus 100.

In general, the utility clasp apparatus 100 includes a first plate 105 and a second plate 110 parallel to the first plate 105. The apparatus 100 typically further includes set of opposable claws 200 disposed between the first and second plates 105, 110. In a typical embodiment, the set of opposable claws 200 includes a first claw half 205 and a second claw half 210 having a common pivot point 215 with the first claw half 205, which is best shown in FIG. 4, which illustrates a front view of an embodiment of opposable claws 200 in an open position. Furthermore, the first claw half 205 and the second claw half 210 are positioned in a partial overlap pattern as discussed further in the description below.

Referring now specifically to FIG. 3, the first plate 105 is positioned in a first plane of orientation P1 and the second plate 110 is positioned in a second plane of orientation P2. The first claw half 205 is positioned in a third plane of orientation P3 and the second claw half210 is positioned in a fourth plane of orientation P4. The overlapping relationship of the first and second claw halves 205, 210 is appreciated particularly in FIG. 3 by the adjacent and parallel arrangement of the third and fourth planes or orientation P3, P4.

Referring to FIGS. 1-4, but most particularly to FIG. 4, it is appreciated that the first claw half 205 and the second claw half 210 each include a base 220, an outer side portion 225 connected to the base 220 and a claw portion 230 connected to the outer side portion 225. In a typical embodiment, the base 220, outer side portion 230 and claw portion 230 are integrally connected and generally form a C-profile. As described above, the respective base portions 220 of the opposable claws 205, 210 are in mechanical contact, as evidenced by the overlapping orientation. In addition, the claw portions 230 are in mechanical contact when the opposable claws 205, 210 are in a closed position as is best seen in FIGS. 1 and 3. It is further appreciated that the base portions 220, the outer side portions 225 and the claw portions 230 form a closed loop when the opposable claws 200 are in a closed position.

In another typical embodiment, the first claw half 205 and the second claw half 210 each further comprise a grip portion 235 integrally connected to the base 220. In general, the grip portions 235 are for pivoting about a pivot point 215 defined between the bases 220. Furthermore, the grip portions 235 are for being pressed toward one another to place the opposable claw halves 205,210 in an open position as best illustrated in FIGS. 2 and 4. In a typical implementation, the grip portions 235 can be pressed together, typically by a user's thumb and index finger, through a direction generally defined by arrows A in FIG. 1. A biasing device 240 is typically disposed between the claw halves 205, 210. In a typical embodiment, the biasing device 240 is a dual coiled spring having a first arm 241 coupled to the first claw half 205 and a second arm 242 connected to the second claw half 210. A coil 243 is disposed on one end of each of the first and second arms 241, 242 and a third arm 244 is disposed between the coils 243. The dual coiled spring allows either of the claw halves to be pivoted and biased independently of the other half. The dual coiled spring also allows both claw halves 205, 210 to be opened simultaneously. In general, the biasing device 240 allows the opposing claws 200 to be biased in a closed position, typically forming a closed loop formed by the bases 220, the outer side portions 225 and the claw portions 230.

A pair of parallel stop-plates 115 is disposed on a lower end of the first and second plates 105, 110 and generally perpendicular to the first and second plates 105, 110. The stop-plates 115 typically limit the motion of the grip portions 235 when the opposable claw halves 205, 210 are placed in an open position. The stop-plates 115 therefore aid in preventing a user from pushing the grip portions 235 too close together, which can over-bias the bias device 240. In general, when a user releases the grip portions 235, the claw halves 205, 210 typically bias to a closed position through a direction generally shown as arrows B.

The first and second plates 205, 210 are generally disposed as to form prongs 120, 125, wherein a channel 130 is formed between the prongs 120, 125. It is appreciated that the closed loop formed by the closed opposable claws 200 is generally retained in the channel 130; the side outer side portions 225 being generally covered by the prongs 120, 125. In a typical implementation of the apparatus, an item placed within the closed loop in the channel 130 such as a latch or loop and the like, is advantageously locked into the closed loop: the overlapped claw portions 230 of the opposable claws 205, 210 being biased in a closed position by biasing device 240 prevents and item from exiting the closed loop under a force in the direction generally shown by arrow C. Therefore, the overlapped claw portions 230 typically function as a gate to and from the channel 130.

The apparatus 100 typically further includes a peak 250 disposed on each of the first claw half 205 and the second claw half 210, and more specifically on a border between the outer side portions 225 and the claw portions 230. A peg 132 is typically disposed between and generally perpendicular to the first and second plates 105, 110 and a terminal end of each of the prongs 120, 125. The pegs 132 function to limit the motion of the opposable claw halves 205, 210 and more specifically the claw portions 230. The peaks 250 come into mechanical contact with a respective peg 132 when the opposable claw halves 205, 210 are in a closed position thereby forming a closed loop. In general, since the biasing device 240 is biasing the claw halves 205, 210 into a closed position, if the claw portions 230 are not limited, the biasing device 240 drives the claw halves too far and the closed loop protrudes and disrupts the space left open by the closed loop in the channel 130. Therefore, the mechanical contact between the peaks 250 and the pegs 132 result in a controlled closed loop within the channel 132.

Referring again to FIGS. 1-3, the apparatus 100 can further include a band 150 disposed between and protruding from the first plate 105 and the second plate 110. In one embodiment, the band 150 is connected between the plates 105, 110 via a through-pin 155 (shown in phantom) disposed between the plates 105, 110. Typically, both ends of the through-pin 155 terminate in the pair of the parallel stop plates 115. As described above, the stop plates 115 are generally disposed perpendicular to and in mechanical contact with the first and second plates 105, 110. Either end of the through-pin 155 are typically threaded and mate with a threaded cap 160 to retain the through-pin to the plates 105, 110 and the stop plates 115.

The band 150 is typically a single length folded upon itself forming a first loop 151 threaded around the through-pin 155, and a second loop 152 threaded through a utility loop 170 onto which items can be disposed and otherwise connected.

In one method of use, the apparatus 100 can be used as a key chain. The opposable claws 200 can be connected to a belt loop and keys can be disposed on the utility loop 170. It is appreciated that the apparatus 100 can be used for a variety of additional purposes.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is at least the following:

1. A utility clasp apparatus, comprising:
a first plate;
a second plate parallel to the first plate; and
a set of opposable claws disposed between the first and second plates.

2. The apparatus as claimed in claim 1 wherein the set of opposable claws comprises:
a first claw half; and
a second claw half having a common pivot point with the first claw half,
wherein the first claw half and the second claw half include a partial overlap pattern.

3. The apparatus as claimed in claim 2 wherein the first claw half and the second claw half each comprise:
a base;
an outer side portion connected to the base; and
a claw portion connected to the outer side portion,
wherein the base, outer side portion and claw portion are integrally connected and generally form a C-profile.

4. The apparatus as claimed in claim 3 wherein the base portions of the opposable claws are in mechanical contact.

5. The apparatus as claimed in claim 3 wherein the claw portions are in mechanical contact when the opposable claws are in a closed position.

6. The apparatus as claimed in claim 3 wherein the base portions, the outer side portions and the claw portions form a closed loop when the opposable claws are in a closed position.

7. The apparatus as claimed in claim 3 wherein the first claw half and the second claw half each further comprise a grip portion integrally connected to the base.

8. The apparatus as claimed in claim 7 wherein the grip portions are for pivoting about a pivot point defined between the bases.

9. The apparatus as claimed in claim 8 wherein the grip portions are for being pressed toward one another to place the opposable claws in an open position.

10. The apparatus as claimed in claim 7 further comprising a pair of parallel stop-plates disposed on a lower end of the first and second plates and generally perpendicular to the first and second plates.

11. The apparatus as claimed in claim 10 wherein the stop-plates limit the motion of the grips when the opposable claws are placed in an open position.

12. The apparatus as claimed in claim 3 further comprising a peak disposed on each of the first claw half and the second claw half.

13. The apparatus as claimed in claim 12 wherein the peaks are disposed on a border between the outer side portion and the claw portion.

14. The apparatus as claimed in claim 13 wherein the first plate and the second plate each comprise a set of prong pairs defining a channel therebetween.

15. The apparatus as claimed in claim 14 further comprising a peg disposed between and generally perpendicular to the first and second plates at a terminal end of each of the prong pairs.

16. The apparatus as claimed in claim 15 wherein the pegs are for limiting the motion of the opposable claws

17. The apparatus as claimed in claim 16 wherein the peaks are in mechanical contact with a respective peg when the opposable claws are in a closed position thereby forming a closed loop.

18. The apparatus as claimed in claim 3 further comprising a channel formed in an end of the first plate and the second plate.

19. The apparatus as claimed in claim 18 wherein the opposable claws form a closed loop within the channel when the opposable claws are in a closed position.

20. The apparatus as claimed in claim 19 wherein the claw portions form an overlapping gate to the channel.

21. The apparatus as claimed in claim 20 wherein the overlapping gate prevents an item from being moveable from the channel.

22. The apparatus as claimed in claim 2 wherein the first plate is positioned in a first plane of orientation and the second plate is positioned in a second plane of orientation.

23. The apparatus as claimed in claim 22 wherein the first claw half is positioned in a third plane of orientation and the second claw half is positioned in a fourth plane of orientation.

24. The apparatus as claimed in claim 1 further comprising a band disposed between and protruding from the first plate and the second plate.

25. The apparatus as claimed in claim 24 wherein the band is connected between the plates via a through pin disposed between the plates.

26. The apparatus as claimed in claim 25 wherein both ends of the through pin terminate in a support plate disposed perpendicular to and in mechanical contact with the first and second plates.

27. The apparatus as claimed in claim 24 further comprising a utility loop connected to one end of the band.
